(19) United States
(12) Patent Application Publication
(10) Pub. No.: US 2025/0235911 A1
(43) Pub. Date: Jul. 24, 2025

(54) METHOD FOR REGENERATING CARBON FIBER BUNDLE AND APPARATUS FOR REGENERATING CARBON FIBER BUNDLE

(71) Applicant: HONDA MOTOR CO., LTD., Tokyo (JP)

(72) Inventor: Masato NOGUCHI, Saitama (JP)

(21) Appl. No.: 18/966,160

(22) Filed: Dec. 3, 2024

(30) Foreign Application Priority Data
Jan. 22, 2024 (JP) 2024-007580

(51) Int. Cl. B09B 3/40; B09B 101/75

(52) U.S. Cl. CPC B09B 3/40; B09B 2101/75

(57) ABSTRACT

Provided is a method for regenerating a carbon fiber bundle from a structure having a hollow substrate, and a carbon fiber reinforced resin layer including a carbon fiber bundle assembly including a plurality of carbon fiber bundles and wound around the hollow substrate, and a matrix resin, the method including a first heating process of heating the structure to decompose a part of the matrix resin, an unwinding process of unwinding the carbon fiber bundle assembly to which decomposition residue of the matrix resin is adhering from the carbon fiber reinforced resin layer in which a part of the matrix resin is decomposed, and a dividing process of dividing the unwound carbon fiber bundle assembly into a plurality of intermediate carbon fiber bundles to which the decomposition residue of the matrix resin is adhering.

This application is based on and claims the benefit of priority from Japanese Patent Application No. 2024-007580, filed on 22 Jan. 2024, the content of which is incorporated herein by reference.

### BACKGROUND OF THE INVENTION

### Field of the Invention

The present invention relates to a method for regenerating a carbon fiber bundle, an apparatus for regenerating a carbon fiber bundle, and a carbon fiber bundle.

### Related Art

In recent years, by preventing generation of waste, and reducing, recycling and reusing waste, efforts to significantly reduce generation of waste have become more and more active. In order to realize this, research and development on methods for recovering carbon fibers from carbon fiber reinforced resin is being conducted.

Japanese Unexamined Patent Application, Publication No. 2022-15366 describes a method for recycling carbon fibers, including a process of thermally decomposing resin in a carbon fiber reinforced resin molded product by first heat treatment, and a process of drawing carbon fibers out of the carbon fiber reinforced resin molded product after the first heating treatment and winding the carbon fibers. At this time, the winding process includes a process that thermally decomposes residue of the resin adhering to the carbon fibers by second heat treatment, and a process of adding a sizing agent to the carbon fibers after the second heat treatment. Furthermore, the carbon fiber reinforced resin molded product is a tank including a liner, and a carbon fiber reinforced resin layer.

Patent Document 1: Japanese Unexamined Patent Application, Publication No. 2022-15366

### SUMMARY OF THE INVENTION

However, when the method for recycling carbon fibers of Patent Document 1 is applied to the case in which a carbon fiber bundle assembly composed of a plurality of carbon fiber bundles is wound around the liner, carbon fibers composing adjacent carbon fiber bundles are intertwined with one another when thermally decomposing the resin residue adhering to the carbon fibers by the second heat treatment. Therefore, it is not possible to divide the plurality of carbon fiber bundles composing the carbon fiber bundle assembly evenly into the original number of bundles and recycle the plurality of carbon fiber bundles.

The present invention has an object to provide a method for regenerating carbon fiber bundles and an apparatus for regenerating carbon fiber bundles that can divide a plurality of carbon fiber bundles composing a carbon fiber bundles assembly evenly into an original number of bundles to regenerate the plurality of carbon fiber bundles, even when the carbon fiber bundle assembly composed of the plurality of fiber bundles is wound around a hollow substrate.

(1) A method for regenerating a carbon fiber bundle from a structure having a hollow substrate, and a carbon fiber reinforced resin layer including a carbon fiber bundle assembly including a plurality of carbon fiber bundles and wound around the hollow substrate, and a matrix resin, the method including a first heating process of heating the structure to decompose a part of the matrix resin, an unwinding process of unwinding an intermediate carbon fiber bundle assembly to which decomposition residue of the matrix resin is adhering from the carbon fiber reinforced resin layer in which a part of the matrix resin is decomposed, a dividing process of dividing the unwound carbon fiber bundle assembly into a plurality of intermediate carbon fiber bundles to which the decomposition residue of the matrix resin is adhering, a second heating process of heating the divided plurality of intermediate carbon fiber bundles to decompose the decomposition residue of the matrix resin, and thereby obtaining a plurality of regenerated carbon fiber bundles, and a winding process of winding the plurality of regenerated carbon fiber bundles.

(2) The method for regenerating a carbon fiber bundle according to (1), wherein in the dividing process, the plurality of intermediate carbon fiber bundles are supported by a plurality of tensioners.

(3) The method for regenerating a carbon fiber bundle according to (2), wherein each of the tensioners includes two leaf springs that hold the intermediate carbon fiber bundle therebetween.

(4) The method for regenerating a carbon fiber bundle according to (2) or (3), wherein the plurality of tensioners are disposed at a predetermined distance apart from each other.

(5) The method for regenerating a carbon fiber bundle according to (4), wherein in the carbon fiber bundle assembly, the plurality of carbon fiber bundles are disposed in parallel in a width direction, and end portions in the width direction of the carbon fiber bundles disposed in parallel alternately overlap each other, and the plurality of tensioners are disposed so that the overlapping end portions of the carbon fiber bundles are separated.

(6) The method for regenerating a carbon fiber bundle according to any one of (1) to (5), wherein the unwound intermediate carbon fiber bundle assembly is temporarily placed, and thereafter, is divided into the plurality of intermediate carbon fiber bundles.

(7) An apparatus for regenerating a carbon fiber bundle from a structure having a hollow substrate, and a carbon fiber reinforced resin layer including a carbon fiber bundle assembly including a plurality of carbon fiber bundles, and wound around the hollow substrate, and a matrix resin, the apparatus including a first heater that heats the structure to decompose a part of the matrix resin, an unwinder that unwinds an intermediate carbon fiber bundle assembly to which decomposition residue of the matrix resin is adhering from the carbon fiber reinforced resin layer in which a part of the matrix resin is decomposed, a divider that divides the unwound intermediate carbon fiber bundle assembly into a plurality of intermediate carbon fiber bundles to which the decomposition residue of the matrix resin is adhering, a second heater that heats the divided plurality of intermediate carbon fiber bundles to decompose the decomposition residue of the matrix resin, and thereby obtains a plurality of regenerated carbon fiber bundles, and a winder that winds the plurality of regenerated carbon fiber bundles.

(8) A regenerated carbon fiber bundle regenerated by the method for regenerating a carbon fiber bundle according to any one of (1) to (6).

According to the present invention, it is possible to provide the method for regenerating carbon fiber bundles and the apparatus for regenerating carbon fiber bundles that can divide a plurality of carbon fiber bundles composing the carbon fiber bundle assembly into an original number of carbon fiber bundles and regenerate the carbon fiber bundles, even when the carbon fiber bundle assembly composed of a plurality of carbon fiber bundles is wound around the hollow substrate.

### BRIEF DESCRIPTION OF THE DRAWINGS

FIG. 1 is a sectional view showing an example of a high-pressure hydrogen tank;

FIG. 2 is a sectional view showing an example of a carbon fiber bundle assembly;

FIG. 3 is a view showing an example of a first heater that is used in a first heating process;

FIG. 4A is a sectional view showing a rotator that rotates the high-pressure hydrogen tank in a heat treatment chamber in FIG. 3;

FIG. 4B is a side view showing the rotator that rotates the high-pressure hydrogen tank in the heat treatment chamber in FIG. 3;

FIG. 5 is a front view showing an example of an unwinder that is used in an unwinding process;

FIG. 6 is a side view showing examples of the unwinder and a divider that are used in the unwinding process and a dividing process;

FIG. 7 is a perspective view showing a tensioner in FIG. 6;

FIG. 8 is a schematic view explaining disposition of the tensioner in FIG. 6;

FIG. 9 is a side view showing a modification of the divider in FIG. 6; and

FIG. 10 is a schematic view showing examples of a second heater, a sizing unit, and a winder that are used in a second heating process, a sizing process, and an winding process.

### DETAILED DESCRIPTION OF THE INVENTION

Hereinafter, an embodiment of the present invention will be described with reference to the drawings.

A method for regenerating a carbon fiber bundle according to one embodiment of the present invention is a method for regenerating a carbon fiber bundle from a structure having a hollow substrate, and a carbon fiber reinforced resin layer including a carbon fiber bundle assembly composed of a plurality of carbon fiber bundles, and wound around the hollow substrate, and a matrix resin. Although the structure is not particularly limited, for example, known high-pressure hydrogen tanks (types 2 to 4) are cited.

Although the carbon fibers composing the carbon fiber bundles are not particularly limited, for example, polyacrylonitrile (PAN) carbon fibers, and pitch carbon fibers are cited. Here, the carbon fibers composing the carbon fiber bundles are long fibers. Fiber lengths of the carbon fibers are not particularly limited, but are 1 m or more, for example. Although the matrix resin is not particularly limited, for example, thermosetting resins such as epoxy resins, and thermoplastic resins are cited.

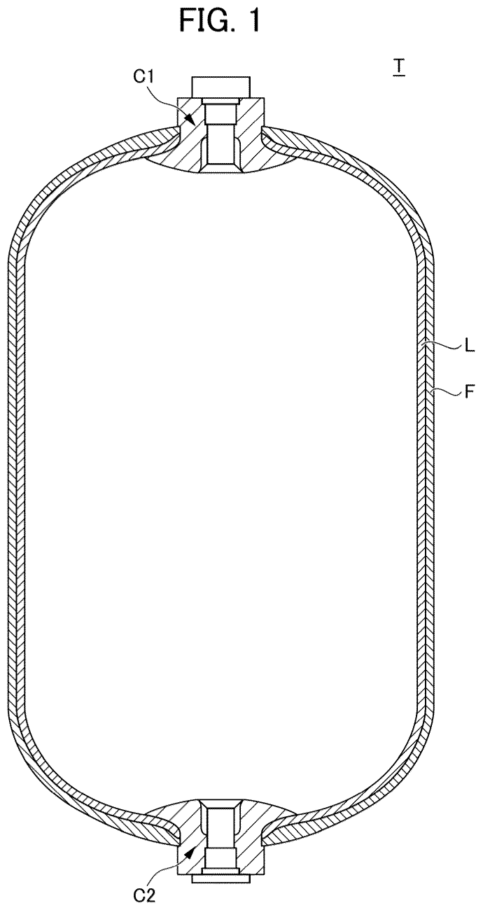

FIG. 1 shows an example of the high-pressure hydrogen tank.

A high-pressure hydrogen tank T has a liner L, as a hollow substrate, a carbon fiber reinforced resin layer F including a carbon fiber bundle assembly that is wound around the liner L and a matrix resin, and mouthpieces C1 and C2 that are installed in both end portions in a lengthwise direction. Although a material forming the liner L is not particularly limited, for example, metal such as aluminum, and chrome molybdenum steel, and resins such as polyamide and polyethylene are cited.

Although the method for manufacturing the high-pressure hydrogen tank T is not particularly limited, for example, a filament winding method is cited.

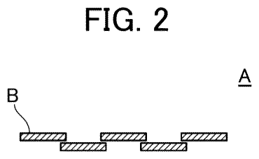

FIG. 2 shows an example of the carbon fiber bundle assembly.

In a carbon fiber bundle assembly A, a plurality of carbon fiber bundles B are disposed in parallel in a width direction. In this case, end portions in the width direction, of the carbon fiber bundles B that are disposed in parallel alternately overlap one another.

The method for regenerating a carbon fiber bundle according to one embodiment of the present invention includes a first heating process of heating the high-pressure hydrogen tank T to decompose a part of the matrix resin, an unwinding process of unwinding an intermediate carbon fiber bundle assembly I1 to which decomposition residue of the matrix resin is adhering from the carbon fiber reinforced resin layer in which a part of the matrix resin is decomposed, and a dividing process of dividing the unwound intermediate carbon fiber bundle assembly I1 into a plurality of intermediate carbon fiber bundles I2 to which the decomposition residue of the matrix resin is adhering. Furthermore, the method for regenerating a carbon fiber bundle according to one embodiment of the present invention further includes a second heating process of heating the plurality of intermediate carbon fiber bundles I2 that are divided to decompose the decomposition residue of the matrix resin, and thereby obtaining a plurality of regenerated carbon fiber bundles R, and a winding process of winding the plurality of regenerated carbon fiber bundles R. Accordingly, carbon fibers that compose the carbon fiber bundles that overlap one another, of the intermediate carbon fiber bundle assembly I1 are not intertwined with one another, and as a result, the plurality of carbon fiber bundles B composing the carbon fiber bundle assembly A are evenly divided into the original number of carbon fiber bundles B and regenerated. Furthermore, since heating of the plurality of intermediate carbon fiber bundles I2 that are divided is promoted, a treatment time of the second heating process is shortened.

The first heating process preferably includes a first step of decomposing the matrix resin at a temperature equal to or higher than a thermal decomposition start temperature of the matrix resin and equal to or lower than a flash point of thermal decomposition gas of the matrix resin, and a second step of decomposing the matrix resin that is decomposed in the first step, at a temperature equal to or higher than a thermo-oxidative decomposition start temperature of the decomposition residue of the matrix resin, and equal to or lower than a thermal decomposition start temperature of the carbon fibers. This suppresses overheating due to combustion of the thermal decomposition gas of the matrix resin, and deterioration of the carbon fibers.

When the matrix resin is an epoxy resin, for example, in the first step, the matrix resin is heated at a temperature of 330° C. or higher and 360° C. or lower, and in the second step, the matrix resin is heated at a temperature of 430° C. or higher ad 470° C. or lower. In this case, as the thermal decomposition gas, bisphenol A, phenol and the like are cited, for example.

Note that the heating temperature in the first heating step is not particularly limited as long as it is possible to unwind the carbon fiber bundles with the decomposition residue of the matrix resin adhering to the carbon fibers.

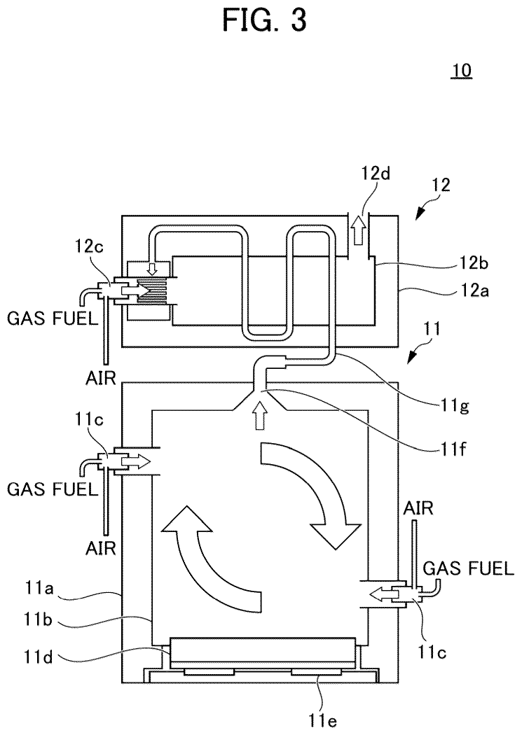

FIG. 3 shows a heat-treating furnace as an example of the first heater that is used in the first heating process.

A heat-treating furnace 10 has a heat treatment chamber 11 and a combustion chamber 12.

The heat treatment chamber 11 is an enclosed space surrounded by an outer wall 11a and an inner wall 11b. Furthermore, in the heat treatment chamber 11, a burner 11c is provided in each of an upper portion of the outer wall 11a on a left side and a lower portion of the outer wall 11a on a right side in the drawing so that combustion gas flows into the inner wall 11b. Accordingly, when gas fuel and air are mixed and combusted with the burners 11c, combustion gas circulates in the inner wall 11b by convection, and a temperature inside the inner wall 11b is stabled.

In the heat treatment chamber 11, a sealing door for containing the high-pressure hydrogen tank T is installed in part of the outer wall 11a and the inner wall 11b. Here, the high-pressure hydrogen tank T is placed on a thermal insulator 11d that is installed to penetrate a bottom surface of the inner wall 11b. Furthermore, a load cell 11e as a mass detector is installed between a bottom surface of the outer wall 11a and the thermal insulator 11d, and detects a mass of the high-pressure hydrogen tank T in real time, based on a distortion amount. Since heating conditions in the heat treatment chamber 11 is thereby optimized, variations in the decomposition amount of the matrix resin due to individual differences in the material forming the high-pressure hydrogen tank T, the shape and the like are suppressed, and management accuracy is improved. Furthermore, since the heating time in the heat treatment chamber 11 does not have to be longer than necessary, this contributes to shortening of the heating time and reduction of energy consumption.

Note that the mass detector may detect a decrease amount of the mass of the high-pressure hydrogen tank T in real time. Furthermore, as necessary, the mass detector may be omitted.

The decomposition gas of the matrix resin generated inside the inner wall 11b is discharged from an exhaust port 11f that is formed in an upper portion of the inner wall 11b in the drawing, and thereafter, is introduced into the combustion chamber 12 via a pipe 11g that is installed by penetrating the outer wall 11a.

The combustion chamber 12 is an enclosed space with a periphery of the combustion chamber 12 surrounded by an outer wall 12a and an inner wall 12b. Furthermore, in the combustion chamber 12, a burner 12c is provided in a center portion of the outer wall 12a on a left side in the drawing so that the combustion gas flows to inside of the inner wall 12b. The pipe 11g penetrates the outer wall 12a, thereafter, penetrates an inside and an outside of the inner wall 12b, in the outer wall 12a, and is finally connected to an upper left portion of the inner wall 12b in the drawing. At this time, while passing through the pipe 11g inside the inner wall 12b, the decomposition gas of the matrix resin is heated by the combustion gas flowing inside the inner wall 12b, thereafter, is introduced from the upper left portion of the inner wall 12b, and contacts the combustion gas. Thereby, the decomposition gas of the matrix resin is combusted, and then is exhausted to the outside from the exhaust port 12d.

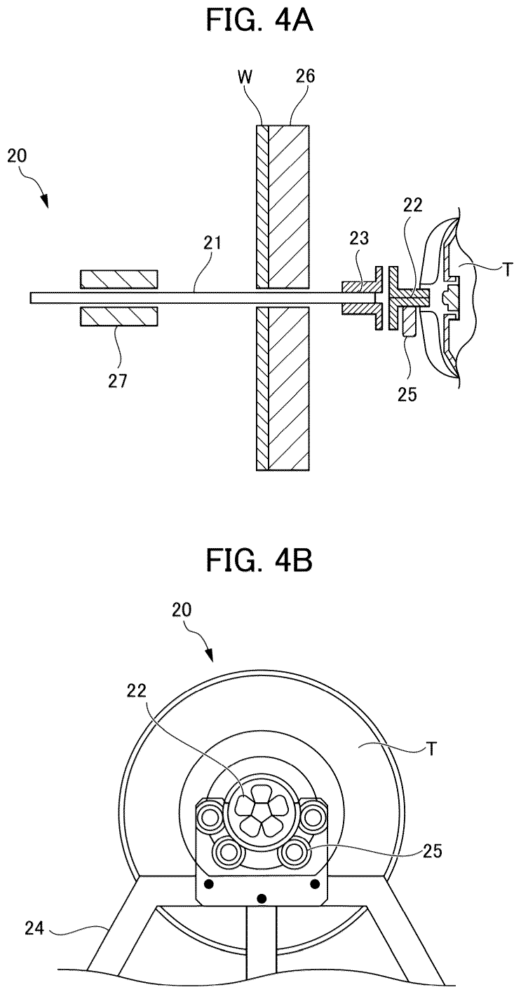

FIG. 4A and FIG. 4B each show an example of a rotator that rotates the high-pressure hydrogen tank T in the heat treatment chamber 11. Note that FIG. 4A and FIG. 4B are respectively a sectional view and a side view.

Since a rotator 20 has a rotating shaft 21 in a substantially horizontal direction penetrating the wall portion W of the heat treatment chamber 11, a temperature distribution in the carbon fiber reinforced resin layer F in the up-down direction in the drawing is made uniform.

Note that the rotating shaft 21 may be in a direction other than the substantially horizontal direction, and may be in a substantially vertical direction, for example. When the rotating shaft 21 is in the substantially vertical direction, the temperature distribution of the carbon fiber reinforced resin layer F in the heat treatment chamber 11 is made uniform to an extent corresponding to the case in which the rotating shaft 21 is in the substantially horizontal direction.

The high-pressure hydrogen tank T is connected to the rotating shaft 21 via a flange-equipped fixture 22 utilizing the shapes of the mouthpieces C1 and C2, and a rotating shaft flange 23. In this case, the flange-equipped fixture 22 and the rotating shaft flange 23 are fixed with bolts and nuts, for example. Furthermore, the high-pressure hydrogen tank T is placed on a pedestal 24, and bearings 25 are installed on the pedestal 24. Furthermore, a thermal insulator 26 is installed inside of the wall portion W of the heat-treating furnace 10. Furthermore, a motor that rotates the rotating shaft 21 is installed outside of the wall portion W of the heat-treating furnace 10, and a cooling jacket 27 is installed around the rotating shaft 21.

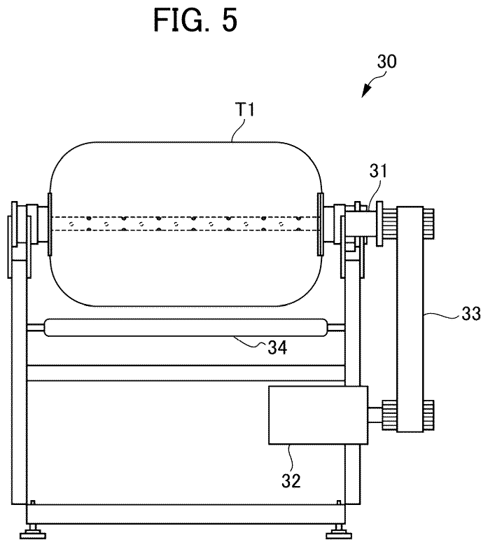

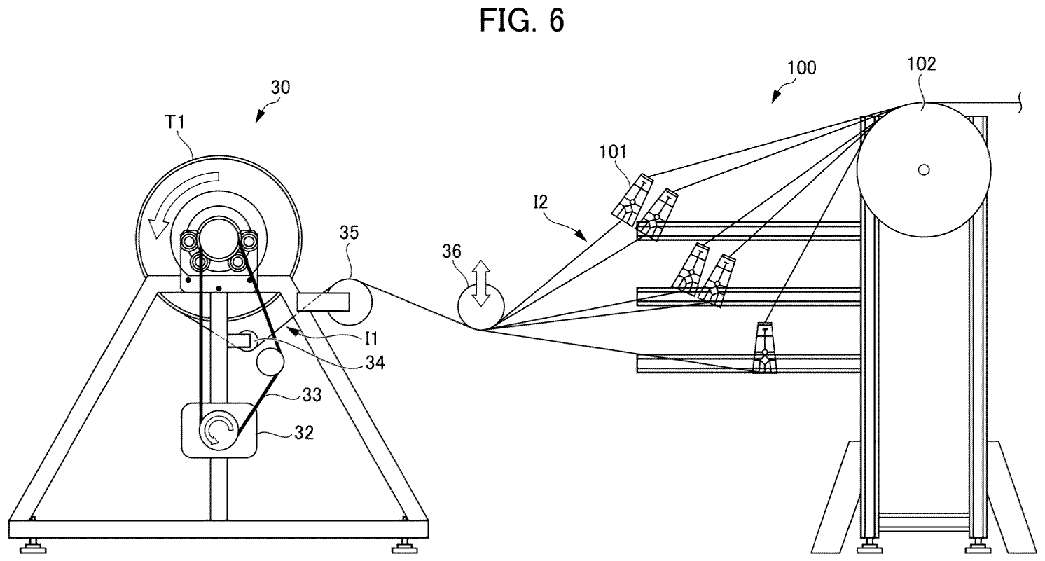

FIG. 5 shows an example of an unwinder that is used in an unwinding process. Furthermore, FIG. 6 shows examples of the unwinder and a divider that are used in the unwinding process and a dividing process.

An unwinder 30 has a rotating jig 31 that rotatably supports a high-pressure hydrogen tank T1 in which a part of the matrix resin is decomposed, and a motor 32 that rotates the high-pressure hydrogen tank T1. Rotational power of the motor 32 is transmitted to the rotating jig 31 via a belt 33. As a result, the intermediate carbon fiber bundle assembly I1 is unwound via rollers 34 and 35. In this case, the roller 34 is disposed so that the intermediate carbon fiber bundle assembly I1 is unwound to outside from a tangent line in a position where the intermediate carbon fiber bundle assembly I1 of the high-pressure hydrogen tank T1 is unwound. Furthermore, the rollers 34 and 35 have long shafts to correspond to unwinding of the intermediate carbon fiber bundle assembly Il in the lengthwise direction of the high-pressure hydrogen tank T1. Furthermore, in order to absorb a difference in an unwinding amount per one rotation by hoop winding and helical winding of the intermediate carbon fiber bundle assembly I1, a dancer roller 36 that controls unwinding tension is installed.

Note that instead of the roller 34, a blade may be installed.

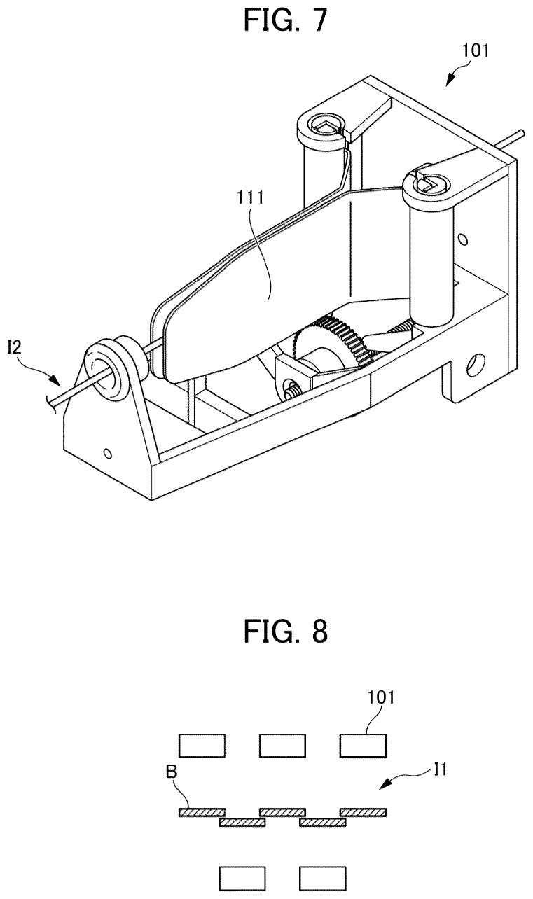

The divider 100 includes a plurality of tensioners 101 that divides the unwound intermediate carbon fiber bundle assembly I1 into the plurality of intermediate carbon fiber bundles 12 to which the decomposition residue of the matrix resin is adhering, and supports the plurality of intermediate carbon fiber bundles 12, and a roller 102 that transports the plurality of intermediate carbon fiber bundles I2. Accordingly, in the winding process, torque that is loaded on a regenerated carbon fiber bundle R is difficult to transmit to the high-pressure hydrogen tank T1, and in addition, tension of the intermediate carbon fiber bundle 12 in the second heating process is adjusted. As shown in FIG. 7, the tensioner 101 is a spring tensioner including two leaf springs 111 that hold the intermediate carbon fiber bundle I2 therebetween. As a commercially available spring tensioner, for example, Spring Leaf Yarn Tensioner (made by Ascotex) is cited. Here, as shown in FIG. 8 a plurality of tensioners 101 are disposed so that the overlapping end portions of the carbon fiber bundles B composing the unwound intermediate carbon fiber bundle assembly Il are separated. That is to say, the tensioners 101 corresponding to the carbon fiber bundles B disposed on an upper side in the drawing are disposed on an upper side from the intermediate carbon fiber bundle assembly I1, and the tensioners 101 corresponding to the carbon fiber bundles B disposed on a lower side in the drawing are disposed on a lower side from the intermediate carbon fiber bundle assembly I1. Therefore, the unwound intermediate carbon fiber bundle assembly I1 is divided into the plurality of intermediate carbon fiber bundles I2.

Note that if the carbon fiber bundle assembly has a configuration composed of a plurality of carbon fiber bundles, the plurality of carbon fiber bundles do not have to be disposed in parallel in the width direction. For example, in the carbon fiber bundle assembly, a plurality of carbon fiber bundles may be stacked in a thickness direction. In this case, the tensioners are disposed according to the disposition of the carbon fiber bundles composing the carbon fiber bundle assembly.

The divider 100 may further have a buffer portion on which the unwound intermediate carbon fiber bundle assembly I1 is temporarily placed. This makes it difficult for the torque loaded on the regenerated carbon fiber bundle R to be transmitted to the high-pressure hydrogen tank T1 in the winding process.

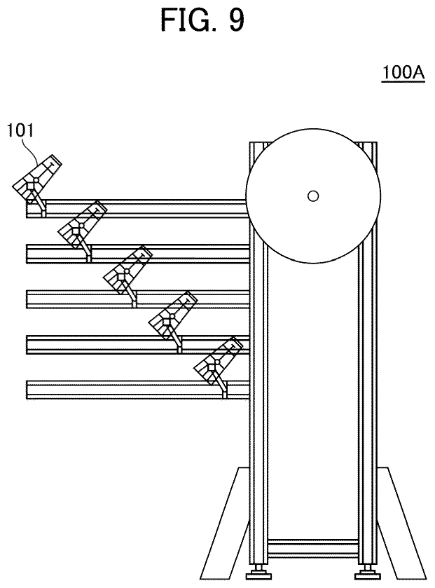

FIG. 9 shows a modification of the divider 100.

A divider 100A has a same configuration as the divider 100 except that a plurality of tensioners 101 are disposed at a predetermined distance (for example, 10 cm) from each other.

A heating temperature in the second heating process is preferably equal to or higher than the heating temperature in the first heating process. This makes it easier to decompose the decomposition residue of the matrix resin adhering to the intermediate carbon fiber bundle 12. On the other hand, the heating temperature in the second heating process is preferably equal to or lower than the thermal decomposition start temperature of the carbon fiber. Thereby, deterioration of the carbon fibers is suppressed.

Note that after the sizing process for sizing the regenerated carbon fiber bundle R is carried out, the regenerated carbon fiber bundle R that is sized may be wound.

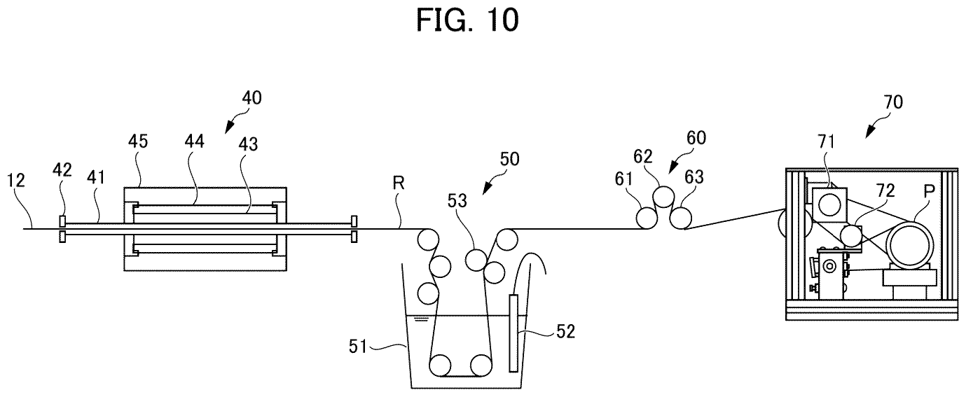

FIG. 10 shows examples of a second heater, a sizing unit, and a winder that are used in the second heating process, the sizing process, and the winding process.

In a tube furnace 40 as the second heater, thermally insulated lids 42 in which through-holes that allow the intermediate carbon fiber bundle 12 to which the decomposition residue of the matrix resin is adhering to pass through are formed are installed at both ends of a quartz tube 41. Furthermore, in the tube furnace 40, a heating wire 43, a thermal insulator 44, and a protection cover 45 are sequentially installed in a center portion of the quartz tube 41. Because of this, by passing an electric current to the heating wire 43, the intermediate carbon fiber bundle 12 is heated, the decomposition residue of the matrix resin is decomposed, and thereby the regenerated carbon fiber bundle R is obtained. At this time, in addition to the temperature distribution in the tube furnace 40 being made uniform, heating of anything other than the intermediate carbon fiber bundle 12 is suppressed.

A sizing unit 50 causes the regenerated carbon fiber bundle R to pass through a sizing liquid 51. At this time, a heater 52 heats the sizing liquid 51. Furthermore, a roller 53 prevents excessive application of the sizing liquid 51 to the regenerated carbon fiber bundle R.

Note that as necessary, a drying furnace may be installed to dry the regenerated carbon fiber bundle R.

A feeding mechanism 60 has feeder rollers 61, 62, and 63, and uses friction between the feeder rollers 61, 62 and 63 and the regenerated carbon fiber bundle R to control a linear speed of the regenerated carbon fiber bundle R to a linear speed that facilitates process management.

A winder 70 includes a winding motor 71 for winding the regenerated carbon fiber bundle R on a paper core P, and a slide roller 72 for traverse winding of the regenerated carbon fiber bundle R. In this case, by controlling torque of the winding motor 71, winding tension of the regenerated carbon fiber bundle R is controlled.

Note that the regenerated carbon fiber bundle R may be opened, or a plurality of regenerated carbon fiber bundles R may be aligned. Furthermore, of the plurality of regenerated carbon fiber bundles R, only the regenerated carbon fiber bundles R derived from the carbon fiber bundles B that are not disposed at both the ends in the width direction of the carbon fiber bundle assembly A may be wound as long fibers. In this case, the regenerated carbon fiber bundles R derived from the carbon fiber bundles B disposed at both the ends in the width direction of the carbon fiber bundle assembly A may be wound as short fibers.

Although the embodiment of the present invention is described above, the present invention is not limited to the above-described embodiment, and the above-described embodiment may be appropriately changed within the scope of the gist of the present invention. For example, as the structures other than the high-pressure hydrogen tank, propeller shafts, safety blocks, low-friction rolls, rotor parts of spindle shaft motors and the like may be used.

### EXPLANATION OF REFERENCE NUMERALS

100, 100A divider
101 tensioner
111 leaf spring
A carbon fiber bundle assembly
B carbon fiber bundle
C1, C2 mouthpiece
F carbon fiber reinforced resin layer
I1 intermediate carbon fiber bundle assembly
I2 Intermediate carbon fiber bundle
L liner
R regenerated carbon fiber bundle
T, T1 high-pressure hydrogen tank

What is claimed is:

1. A method for regenerating a carbon fiber bundle from a structure having a hollow substrate, and a carbon fiber reinforced resin layer including a carbon fiber bundle assembly comprising a plurality of carbon fiber bundles and wound around the hollow substrate, and a matrix resin, the method comprising:
a first heating process of heating the structure to decompose a part of the matrix resin;
an unwinding process of unwinding the carbon fiber bundle assembly to which decomposition residue of the matrix resin is adhering from the carbon fiber reinforced resin layer in which a part of the matrix resin is decomposed;
a dividing process of dividing the unwound carbon fiber bundle assembly into a plurality of intermediate carbon fiber bundles to which the decomposition residue of the matrix resin is adhering;
a second heating process of heating the divided plurality of intermediate carbon fiber bundles to decompose the decomposition residue of the matrix resin, and thereby obtaining a plurality of regenerated carbon fiber bundles; and
a winding process of winding the plurality of regenerated carbon fiber bundles.

2. The method for regenerating a carbon fiber bundle according to claim 1, wherein in the dividing process, the plurality of intermediate carbon fiber bundles are supported by a plurality of tensioners.

3. The method for regenerating a carbon fiber bundle according to claim 2, wherein each of the tensioners comprises two leaf springs that hold the intermediate carbon fiber bundle therebetween.

4. The method for regenerating a carbon fiber bundle according to claim 2, wherein the plurality of tensioners are disposed at a predetermined distance apart from each other.

5. The method for regenerating a carbon fiber bundle according to claim 4, wherein,
in the carbon fiber bundle assembly, the plurality of carbon fiber bundles are disposed in parallel in a width direction, and end portions in the width direction of the carbon fiber bundles disposed in parallel alternately overlap each other, and
the plurality of tensioners are disposed so that the overlapping end portions of the carbon fiber bundles are separated.

6. The method for regenerating a carbon fiber bundle according to claim 1, wherein the unwound intermediate carbon fiber bundle assembly is temporarily placed, and thereafter, is divided into the plurality of intermediate carbon fiber bundles.

7. An apparatus for regenerating a carbon fiber bundle from a structure having a hollow substrate, and a carbon fiber reinforced resin layer including a carbon fiber bundle assembly comprising a plurality of carbon fiber bundles, and wound around the hollow substrate, and a matrix resin, the apparatus comprising:
a first heater that heats the structure to decompose a part of the matrix resin;
an unwinder that unwinds the carbon fiber bundle assembly to which decomposition residue of the matrix resin is adhering from the carbon fiber reinforced resin layer in which a part of the matrix resin is decomposed;
a divider that divides the unwound carbon fiber bundle assembly into a plurality of intermediate carbon fiber bundles to which the decomposition residue of the matrix resin is adhering;
a second heater that heats the divided plurality of intermediate carbon fiber bundles to decompose the decomposition residue of the matrix resin, and thereby obtains a plurality of regenerated carbon fiber bundles; and
a winder that winds the plurality of regenerated carbon fiber bundles.

8. A regenerated carbon fiber bundle regenerated by the method for regenerating a carbon fiber bundle according to claim 1.
